(19) United States
(12) Patent Application Publication
(10) Pub. No.: US 2003/0056065 A1
(43) Pub. Date: Mar. 20, 2003

(54) Method and device for memory monitoring, in particular for RAM monitoring

(76) Inventor: Thilo Jahn, Venissieux (FR)

Correspondence Address: KENYON & KENYON, ONE BROADWAY, NEW YORK, NY, 10004, US

(21) Appl. No.: 10/243,227

(22) Filed: Sep. 13, 2002

(30) Foreign Application Priority Data
Sep. 15, 2001 (DE) 101 45 621.2

(51) Int. Cl. G06F 12/00

(52) U.S. Cl. 711/154; 711/104

(57) ABSTRACT

A method of monitoring a memory of a microcomputer, in particular a RAM memory, using the following steps: provision of a contiguous memory area, in particular a RAM area, which is assigned to a program part to be executed, in particular a task; storage of data to be stored, assigned to the program part, in the contiguous memory area assigned to the particular program part; upon exiting the program part, determination of a check sum on the basis of the data stored in the contiguous memory area; checking of the check sum upon reentry into the program part and/or in regular intervals between exiting from and reentry into the program part; and identification of memory errors, in particular RAM errors, on the basis of a comparison of the check sum ascertained upon exiting the program part and a subsequently obtained and checked check sum.

### FIELD OF THE INVENTION

The present invention relates to a method and a device for monitoring of memories, in particular RAM (random-access memory) memories of computers. The present invention further relates to a computer program and a computer program product, each having program code arrangement, which allows memory monitoring to be implemented during their execution on a computer or a computing unit.

### BACKGROUND INFORMATION

It is known that the content of RAM cells is subject to be unintentionally changed during the operation of a computer due to external electromagnetic influences. The RAM cells can lose their content due to cosmic radiation, for example. For the detection of such errors, hardware-based and software-based methods are known. As a hardware method it is conceivable, for example, to design RAM memories using parity bit devices, i.e., check bit devices. In order to detect errors, memory cell contents or bytes are enhanced using artificial redundancy. For example, the number of binary coded “one”s in a byte are set at an even number, including the check bit, and are checked. It is equally effective to set this number at an uneven number and check it (imparity check). The latter form is mostly used in computers. As a software method, it is conceivable to double store the RAM cells and/or their contents (redundant storage).

The described hardware method is relatively complex, which results in higher preparation costs. A software method should preferably monitor all stored values, which results in a very high tie-up of resources with regard to memory capacity and computing time.

The above-mentioned problems are found, for example, during the operation of an electronic control unit having a microprocessor used in motor vehicles. It is important here to check preferably all RAM cells utilized for data consistency in certain time intervals. As mentioned, the content of such RAM cells can be altered by external or also internal electromagnetic influences, like cosmic radiation, for example, whereby alterations of single bits or also a plurality of bits can occur.

Checking a processor regularly for faultless operation, while watchdog functions and plausibility inspections are implementable, is known in this connection. However, RAM errors are detected here only when the internal operations are interrupted or when calculations, based on the content of a faulty RAM cell and executed by the control unit, lie outside of pre-settable system limit values.

It should be noted that current software structures attempt to rewrite RAM cells in intervals as short as possible in order to minimize such effects. Access to safe data, like data stored in a ROM memory, for example, cannot be ensured, because as a rule, computing results are ascertained under consideration of data stored in the other RAM cells. However, the other RAM cells are to be considered as potentially unsafe data sources.

To circumvent such problems in control units, it is possible to double store system variables identified as important in a RAM memory and to continuously and regularly compare them with one another. The disadvantage of such a method, however, is the fact that a programmer, due to the complexity of the systems to be considered, is frequently not able to assess which data represent important system variables and should be double stored. Because of cost reasons, conventional RAM resources in motor vehicle systems are not designed for double storage of all system variables.

### SUMMARY OF THE INVENTION

Therefore, it is an object of the present invention to implement memory monitoring, in particular RAM monitoring, in a manner as simple and safe as possible in order to overcome the problems mentioned above.

The method according to the present invention provides a low-cost and very cost-effective method for the monitoring of RAM cells, without requiring a modification of hardware and which operates in a resource-saving manner and is able to monitor all system variables or system values. Due to the method according to the present invention it is possible to detect RAM errors, which are not detected by the installed conventional protective mechanisms when calculations, executed based on faulty RAM data, lie within pre-settable system limit values. Such RAM errors are, however, able to significantly influence computing results, thus precipitating an operational hazard of a motor vehicle. It should be noted as an example that due to the presence of even one false bit, a preset idle speed may be too high, causing the control unit to supply fuel and accelerate the vehicle.

Contiguous memory areas are understood in particular as continuously addressable memory cells. Such memory areas are distinguished by the fact that the memory area is fully defined by the start address and the end address, so that the computing complexity when calling the memory area is very small. It is also possible to combine not directly adjacent memory cells into a contiguous area via appropriate combination of the addresses. It is possible also to determine a check sum for such memory areas.

The device according to the present invention allows the implementation of the method according to the present invention.

The method according to the present invention is providable as a computer program having a program code arrangement. It is practical here to implement the program code arrangement in connection with a computer program product.

According to a preferred embodiment of the method according to the present invention the check sum is provided in the form of a CRC or cyclic redundancy check, in particular a 16-bit CRC or a 32-bit CRC. In particular 16-bit CRC's are appendable to contiguous RAM areas in a simple manner. By using them it is possible to check anytime whether the stored area has retained its inherently correct form, the execution of such a check being very quick.

The contiguous memory areas are preferably provided manually or by the use of offline tools, via which single elements and/or memory cells of a task may be linked together. Manual linkage is to be understood here in particular as a linkage in a low-level language, the assembler language, for example. In such languages, individual memory cells are designable to have appropriate linkages. However, a linkage using offline tools, in a high-level language, for example, is preferred. Here, a linker is provided with a list, where cells having the same properties, for example, are predefined (association with a task). On the basis of such a list, the linker is then able to clearly assign the frame memory cells to a task.

Upon detection of an error, it is preferred to restart a software running on the microcomputer. Using this measure, the calculations of the particular RAM cell contents may be reinitialized. The driver may notice such a restart by a onetime jerk of his vehicle; the occurrence of such problems is relatively infrequent.

Preferably, a statistical analysis of detected errors is executed. Such a statistical analysis may include, for example, entering an error into an error memory and storage of the frequency of occurrence of certain errors. Using a statistical analysis makes it possible, for example, to identify design problems of the overall system.

Particular advantages of the method according to the present invention include a full monitoring of all RAM cells, a minimal extra RAM requirement, as well as quick response times.

### BRIEF DESCRIPTION OF THE DRAWINGS

FIG. 1 shows a diagram illustrating the chronological sequence of two tasks within a program flow.

FIG. 2 shows a memory architecture typically provided within the scope of the present invention.

FIG. 3 shows a schematic block diagram of a microcomputer on which the present invention is implementable.

### DETAILED DESCRIPTION

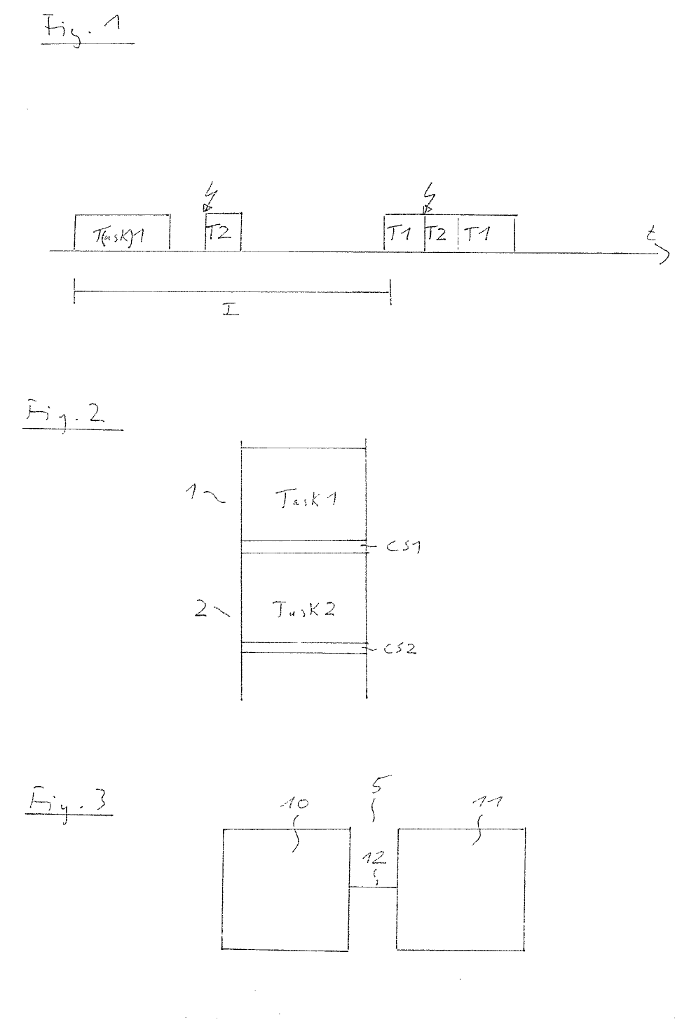

With regard to FIG. 1 it is assumed that task 1 is called in a time-controlled manner and task 2 is called in an event-controlled manner. It is recognizable that an interval I lies between two calls of task 1; the interval may amount to 50 milliseconds, for example. Furthermore, it is assumed that task 2 is able to interrupt task 1. Starting from the left side of the time axis, it is recognizable that task 1 is initially executed completely. Task 2 takes place between two calls of task 1, so that no interruption of task 1 occurs.

When task 1 is called again, the event actuating task 2 takes place before task 1 is executed, so that task 1 is interrupted. Then the continuation or complete execution of task 1 takes place directly following the execution of task 2.

Thus, no large, contiguous program is continuously executed; in fact individual functions, which are called by a timer or an event, are integrated into the tasks. Preferably, each function is built into only one individual task, which in each case writes only to its “own” RAM cells uniquely assigned to it.

For monitoring the RAM cells according to the present invention, these RAM cells which are written to by a task are combined in a block in the memory. Subsequently a check sum is created for each task. After completion of the task, the check sum is calculated and may be checked frequently as long as the task is not running. The latest possible check takes place when the task is restarted. Thus, the response time in the event of errors, as well as the RAM requirements, are minimized. For example, the check sum is determined by using 16-bit or 32-bit CRC methods. The corresponding RAM requirement therefore amounts to 2 or 4 bytes per task.

In the illustrated exemplary embodiment, task 2 is able to interrupt task 1. It is also conceivable that the tasks may interrupt each other. A task overhaul, i.e., a restart of a task prior to its completion, should preferably not be permitted or should be intercepted by the operating system.

Furthermore, it should be pointed out that processor configurations, for example, particular function registers, continue to have to be written to frequently, or are monitored via a redundant double storage. Here, however, a great probability exists that in the event of an error the conventional processor monitoring (watchdog) intervenes.

In the event of an identified error, a restart of the software is preferably executed in order to reinitialize the necessary calculations.

A RAM memory is schematically illustrated in FIG. 2. Memory sections assigned to task 1 and task 2 are clearly recognizable. The individual memory cells of the memory sections are not explicitly shown. Furthermore, it is recognizable that check sums CS 1 and CS 2 are assigned to particular tasks 1 and 2. The check sums are stored in particular memory cells.

Task 1 and task 2 may only be written into memory areas 1 and 2 respectively. However, read-out of data from these individual areas within the scope of any functions or tasks of the overall program is possible.

Monitoring of RAM cells (memory area 1) assigned to task 1 takes place by applying check sum CS 1 to all RAM cells in area 1. Check sum 1 is calculated after completion of task 1 and may be frequently checked as long as task 1 is not running (at restart of task 1 at the latest). Therewith it is possible, according to the present invention, to minimize the response time in the event of errors, as well as the RAM requirement. The same applies to memory area 2, assigned to task 2, for which check sum CS 2 is provided.

Finally, FIG. 3 shows a microcomputer in schematic view, on which the present invention is implementable. The overall microcomputer is indicated here using number 5. The microcomputer includes a microprocessor 10 and a memory 11. Memory 11 is preferably designed as a RAM memory. Microprocessor 10 and memory 11 are connected to each other via a bus 12. By programming the microprocessor the steps according to the present invention are implementable, such as the provision of contiguous memory areas for memory 11, the storage of particular data in the respective contiguous memory areas, the determination of a check sum, and checking of the check sum. On the basis of a comparison of appropriately determined check sums, microprocessor 10 is able to detect errors of memory 11. For the sake of completeness it should be pointed out that memory 11 may have a memory architecture as mentioned above with reference to FIG. 2.

What is claimed is:

1. A method of monitoring a memory of a microcomputer, comprising:
providing a contiguous memory area assigned to a program part to be executed;
storing data to be stored assigned to the program part in the contiguous memory area;
upon exiting the program part, determining a check sum on the basis of the data stored in the contiguous memory area;
checking the check sum at least one of upon reentry into the program part and in regular intervals between exiting from and reentry into the program part; and
identifying a memory error on the basis of a comparison of the check sum determined upon exiting the program part and a subsequently determined and checked check sum.

2. The method as recited in claim 1, wherein:
the memory includes a RAM memory, and
the program part includes a task.

3. The method as recited in claim 1, wherein:
the check sum is determined according to a CRC operation.

4. The method as recited in claim 3, wherein:
the CRC operation includes one of a 16-bit CRC operation and a 32-bit CRC operation.

5. The method as recited in claim 1, wherein:
the contiguous memory area is provided one of manually and by using an offline tool.

6. The method as recited in claim 2, wherein:
the RAM memory includes at least one RAM cell, and
upon detection of the memory error in the at least one RAM cell, a restart of a software running on the microcomputer is executed.

7. The method as recited in claim 1, further comprising:
statistically analyzing the memory error that is identified.

8. A device for monitoring a memory of a microcomputer, comprising:
an arrangement for providing a contiguous memory area assigned to a program part to be executed;
an arrangement for storing data to be stored assigned to the program part in the contiguous memory area;
an arrangement for, upon exiting the program part, determining a check sum on the basis of the data stored in the contiguous memory area;
an arrangement for checking the check sum at least one of upon reentry into the program part and in regular intervals between exiting from and reentry into the program part; and
an arrangement for identifying a memory error on the basis of a comparison of the check sum determined upon exiting the program part and a subsequently determined and checked check sum.

9. The device as recited in claim 8, wherein:
the memory includes a RAM memory, and
the program part includes a task.

10. A storage device for storing a program code that when executed results in a performance of:
providing a contiguous memory area assigned to a program part to be executed;
storing data to be stored assigned to the program part in the contiguous memory area;
upon exiting the program part, determining a check sum on the basis of the data stored in the contiguous memory area;
checking the check sum at least one of upon reentry into the program part and in regular intervals between exiting from and reentry into the program part; and
identifying a memory error on the basis of a comparison of the check sum determined upon exiting the program part and a subsequently determined and checked check sum.
